(19) United States
(12) Patent Application Publication
(10) Pub. No.: US 2016/0137909 A1
(43) Pub. Date: May 19, 2016

(54) System To Efficiently Deliver High Pour Point Chemicals To Oil Well Formations

(71) Applicant: Energy & Environmental Services, Inc., Oklahoma City, OK (US)

(72) Inventors: Melvin B. Smith, Oklahoma City, OK (US); Benjamin Kyle Stringer, Missouri City, TX (US)

(21) Appl. No.: 15/007,838

(22) Filed: Jan. 27, 2016

Related U.S. Application Data
(63) Continuation-in-part of application No. 14/881,995, filed on Oct. 13, 2015.
Application No. 14/881,995 is a continuation-in-part of application No. 14/236,022, filed on Mar. 24, 2014.
(60) Provisional application No. 62/108,118, filed on Jan. 27, 2015.
(60) Provisional application No. 62/063,054, filed on Oct. 13, 2014.

(51) Int. Cl. C09K 8/70; C09K 8/52; C09K 8/62; C09K 8/54

(52) U.S. Cl. CPC C09K 8/70; C09K 8/54; C09K 8/52; C09K 8/62; C09K 2208/32; C09K 2208/12

(57) ABSTRACT

A solid chemical delivery system for delivering chemicals to an underground formation. The solid chemical is formed by dehydrating amorphous silica to form anhydrous silica. High pour point well chemicals are heated to reduce viscosity then introduced to the silica and form a tablet or pelletized chemical. The pelletized chemical is coated to further time-release the introduction of the chemical. The pelletized solid chemical may be delivered to the underground formation through the well bore with a proppant and fracturing fluid.

### CROSS REFERENCE TO RELATED APPLICATION

This application claims the benefit of U.S. Provisional Patent Application Ser. No. 62/108,118, filed Jan. 27, 2015, and is a continuation-in-part of U.S. patent application Ser. No. 14/881,995 filed Oct. 13, 2015, which claims the benefit of U.S. Provisional Patent Application Ser. No. 62/063,054 filed Oct. 13, 2014, and is also a continuation-in-part of U.S. patent application Ser. No. 14/236,022, filed on Mar. 24, 2014, which is a 371 of PCT Application Serial No. PCT/US2012/032376, filed Apr. 5, 2012, the entire contents of which are incorporated herein by reference.

### FIELD

The present invention relates to hydraulic fracturing and delivery methods for well treatment chemicals.

### SUMMARY

The invention is directed to a method for delivering a well treatment chemical into a wellbore. The method comprises providing a precipitated amorphous silica matrix, heating a high pour point well treatment chemical to reduce its viscosity, mixing the high pour point well treatment chemical with the precipitated amorphous silica matrix, cooling the high pour point well treatment chemical within the precipitated amorphous silica matrix to form a first solid treatment device, and providing the first solid treatment device to an underground formation.

### BRIEF DESCRIPTION OF THE DRAWINGS

FIG. 1 is a diagrammatic representation of an injection well and material delivery system for delivery of the well treatment chemical created in the process of FIG. 2.

FIG. 2 is a flow chart demonstrating a process of creating the solid well treatment chemical of the present invention.

FIG. 3 is a diagrammatic representation of a process for coating the present invention.

### DETAILED DESCRIPTION OF THE DRAWINGS

A hydraulic fracture is formed by pumping the fracturing fluid into the wellbore at a rate sufficient to increase pressure downhole to exceed that of the fracture gradient of the rock. The rock cracks and the fracture fluid enter the rock, extending the crack. To keep this fracture open after the injection stops, a solid proppant, commonly sand, is added to the fluid. The propped fracture is permeable enough to allow the flow of formation fluids to the well. Formation fluids include gas, oil, salt water, fresh water and fluids introduced to the formation during completion of the well during fracturing.

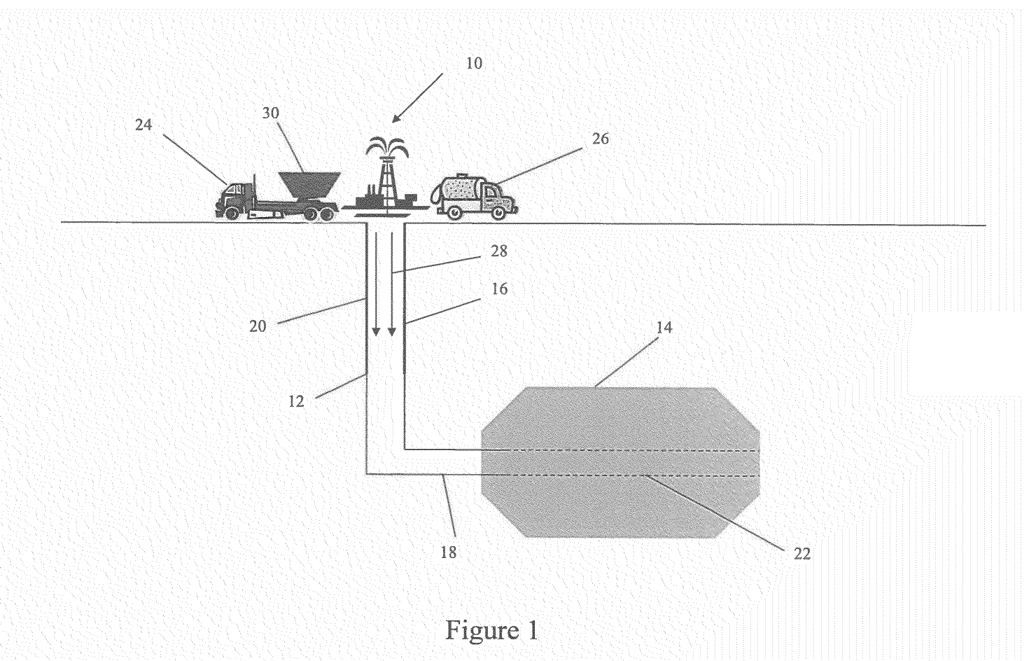

Turning to the figures in general and FIG. 1 specifically, shown therein is an injection well 10 for use with the claimed invention. The injection well comprises a well shaft 12 within a subterranean formation 14. The well shaft 12 comprises a vertical shaft 16 and may comprise a horizontal section 18. Further, the well shaft 12 comprises a well casing 20 that is adapted to seal a portion of the well shaft 12 such that fluids may not travel into or out of the subterranean formation 14 proximate the well casing. The well shaft 12 further comprises a production portion 22 that does not have a well casing 20 such that well treatment chemicals, such as fracturing chemicals, may be delivered to the subterranean formation 14 and desired products such as oil, natural gas, and natural gas liquids are removed from the subterranean formation.

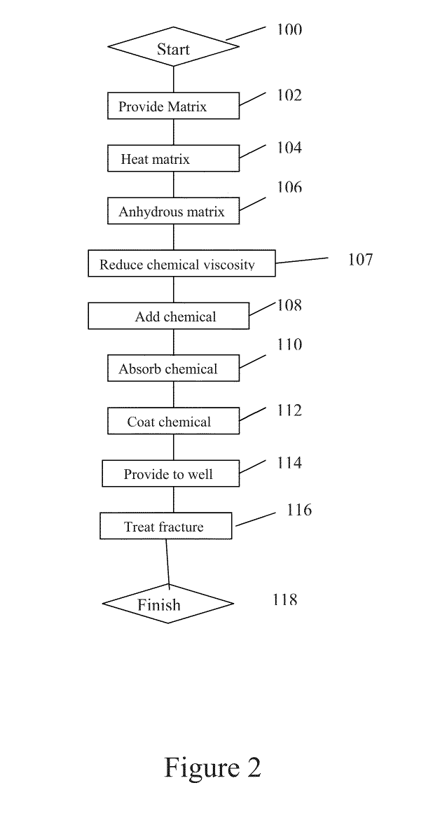

A material delivery system 24 is provided at ground level proximate the injection well 10. The material delivery system 24 delivers products into the well shaft 12 for enhancement of the drilling process. The material delivery system is preferably used in conjunction with a fracturing system 26 for delivery of ground level fracturing fluid 28 into the well shaft 12. The fracturing fluid 28, when delivered to the subterranean formation 14, causes hydraulic fracture and allows delivery of proppant and well treatment chemicals. The material delivery system 24 comprises a solid composite 30 which is created through the process of FIG. 2. Preferably, the solid composite 30 is a precipitated, amorphous silica matrix that is heated and mixed with a liquid well treatment product in the method described in FIG. 2 to form a solid chemical. A precipitated silica matrix is preferred over other silica carriers, such as diatomaceous earth or lava rock, as precipitated silica allows for a much greater rate of adsorption of liquid well treatment product per gram.

With reference now to FIG. 2, a method for creating an enhanced well treatment product, also known herein as a solid composite 30, for delivery to the subterranean formation 22 by the material delivery system 24 (FIG. 1) is shown. As one skilled in the art will appreciate, liquid products have associated weaknesses, such as immediate delivery to a treatment location and an inability to control the delivery of chemical product over time. Use in solution may cause a liquid chemical to dilute significantly, causing the attributes of the chemical to be less effective at a treatment portion of a well bore. The method shown in FIG. 2 provides a process for creating a solid composite 30 in a solid matrix form. The method starts at 100. An amorphous, preferably precipitated silica matrix is provided at 102. The silica matrix is heated at 104 to drive off moisture contained therein, which maximizes the carrying capacity of the silica. When the moisture is removed, an anhydrous silica is left at 106. The anhydrous silica is mixed with a well treatment chemical and enzyme at 108 and the well treatment chemical is absorbed within the interstitial spaces of the anhydrous silica matrix at 110 to form a solid chemical composite. The solid composite may then be coated at 112. The heating of the fracturing fluid 28 may take place before or after the solid chemical is added to the fracturing fluid. The solid chemical, a proppant, and the fracturing fluid 28 are provided to the wellbore at 114. This causes the solid chemical to be positioned within the subterranean formation 14 and more particularly a fracture therein created by the fracturing fluid, providing a metered release of well treatment chemical at 116. The method ends at 118.

Certain chemicals, known as “high pour-point” chemicals, may be difficult to provide to a formation due to their viscous nature or high melting point. Thus, placement of such chemicals within the interstitial spaces of precipitated, amorphous silica may require the reduction of viscosity of the high pour point chemicals at 107. In order to decrease the viscosity, the high pour-point chemicals may be heated prior to incorporation with the precipitated silica matrix in a fluidized bed at 108. Alternatively, a vacuum pressure may be applied to the bed and the chemical at 107 to reduce the viscosity. The solid composite 30 is then cooled and perhaps coated at 112 before incorporation into a wellbore at 114. Additionally, guar powder or other “dry-on-the-fly” techniques may be used to remove excess chemical from the surface of the solid composite 30.

Use of such high-pour point chemicals as the well treatment chemical has multiple benefits. No solvents are required which allows the chemicals to be applied to the silica at a higher concentration. As shown in the below figure, the high density liquid, if you can load it into the silica, will have a very high loading percentage by weight. Precipitated silica can have a surface area in excess of 80 square meters per gram—preferably over 100 square meters per gram. This high surface area will allow very high loading capacities—perhaps as much as 80% by volume, as described in the figure below. By reducing the viscosity of dense liquids, the solid composite 30 can load more treatment chemical on the precipitated silica matrix.

| Density | | | | |
|---|---|---|---|---|
| of Liquid | Weight | Volume | % Loading | % Loading |
| (g/mL) | Ratio | Ratio | by Weight | by Volume |
| 0.6 | 1.1 | 4.1 | 53% | 80% |
| 0.7 | 1.8 | 4.1 | 64% | 80% |
| 0.8 | 2.0 | 4.1 | 67% | 80% |
| 0.9 | 2.3 | 4.1 | 69% | 80% |
| 1.0 | 1.9 | 4.1 | 65% | 80% |
| 1.1 | 2.8 | 4.1 | 73% | 80% |
| 1.2 | 3.0 | 4.1 | 75% | 80% |
| 1.3 | 3.3 | 4.1 | 76% | 80% |
| 1.4 | 3.5 | 4.1 | 78% | 80% |
| 1.5 | 3.8 | 4.1 | 79% | 80% |
| 1.6 | 4.0 | 4.1 | 80% | 80% |

When well treatment chemicals are converted into dry form and loaded into the solid composite 30, incompatible chemistries may be used together. For example, polar and non-polar compounds, ionic and anionic compounds, acids and bases, etc., may be utilized at the same time, as the reactivity of such compounds will be retarded by the slow release of well treatment chemical from the solid composite. Dry composite may be utilized in cold environments without requiring special handling. The solid nature of the silica component of the composite cause the composite 30 to resist being flushed out of a position within a fracture of a wellbore by liquid movement.

The solid chemical may comprise a silica spheroid, a silica pellet, or other shape. Preferably, the solid chemical silica matrix is a porous anhydrous silica spheroid. A dimpled spheroid may also be utilized. As used herein, the well treatment chemical comprises an advantageous chemical such as a scale inhibitor, corrosion inhibitor, paraffin product, H₂S scavenger, or foamer. Additionally, the product could be an emulsifier, non-emulsifier, wetting agent, sludge preventive, retarder, suspension agent, anti-swelling agent, or stimulation additive.

Enzymes may be packaged with the solid chemical well treatment product 30 as a part of the solid chemical silica matrix created at step 102. Enzymes used for these purposes may comprise lipases, proteases and amylases. Enzymes, when used together in the solid composite with the well treatment product, promote more efficient delivery of well treatment product to the subterranean formation 14. Heating the well treatment product 30 through providing heated fracturing fluid 28 alone or in conjunction with an enzyme may improve the ability of the well treatment product to enter the fracture of the subterranean formation 14.

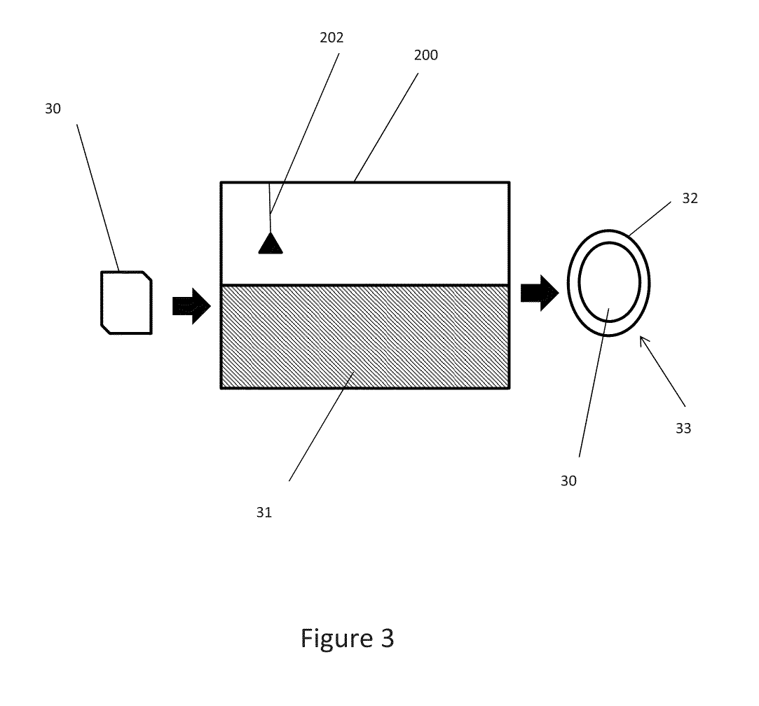

With reference to FIG. 3, a coating 31 may be provided on an outer surface of the solid composite 30. The coating 31 may comprise a polyvinylidene chloride (“PVDC”) resin such as SARAN™. Methods for coating solids with these particular coating substances may be found in U.S. Pat. No. 3,264,131, issued to Nagel, and U.S. Pat. No. 5,373,901, issued to Norman, et al. In both references, a fluidized bed 200 is utilized to apply the coating to a product. A spray coating system 202 may also be utilized. In the present method, the well treatment product 30 is coated with a coating 31 prior to the step of providing the coated solid chemical 33 to the wellbore at 114 (FIG. 2).

The encapsulating material 32 making up the coating 31 may comprise a partially hydrolyzed acrylic, preferably in an aqueous based form which is cross-linked either with an aziridine prepolymer or a carbodiimide. The encapsulating material 31 is preferably admixed with a particulate micron-sized material such as silica dust of a size range from 1 micron to 15 microns. Preferably, the silica comprises from 0%-60% by weight of the coating 32 solids. The encapsulating material 31, when applied to the well treatment chemical 30, may bias to the shape of the coated well treatment chemical 33 to a spheroid or ellipsoid.

The coating 32 thickness may be adjusted to provide time-delay of the release of the well treatment product 30. As one skilled in the art will appreciate, liquid products have associated weaknesses, such as immediate delivery to a treatment location and an inability to control the delivery of chemical product over time. Similarly, time-release matrices such as that previously invented by the applicant may provide a set time-release, but in mineral production applications, time-release on the order of years is desired. The coatings chosen, thicknesses of the coatings, porosity of coatings, solubility of the coatings, and the percentage of well treatment chemical 30 coated by said coatings will meter the release of well treatment chemical. Alternatively, various coatings could be used having differing properties to similarly meter the release of well treatment chemicals. Water-based coatings may be preferred, but are not required to perform the steps of the disclosed invention.

Targeted time-release of well treatment chemicals from the solid composite may be achieved by using a coating on chemicals that are to be released later, or may be a function of the migration of the well treatment chemical out of the interstitial spaces of the silica matrix when in the wellbore.

One skilled in the art can envision other potential combinations of the principles disclosed in the above embodiments. For example, multiple kinds of well treatment chemical can be used together and time-released for different periods. Coatings and the use of high-pour point chemicals will make the predictable, timed release of disparate—and perhaps incompatible when reaction is possible—well treatment chemicals. Additionally, while an amorphous anhydrous silica delivery system for the well treatment product 30 is disclosed, other delivery systems such as ceramic, diatomaceous earth, lava rock, etc., may be utilized.

What is claimed is:

1. A method for delivering a well treatment chemical into a wellbore comprising:
providing a precipitated amorphous silica matrix;
heating a high pour point well treatment chemical to reduce its viscosity;
mixing the high pour point well treatment chemical with the precipitated amorphous silica matrix;
cooling the high pour point well treatment chemical within the precipitated amorphous silica matrix to form a first solid treatment device; and
providing the first solid treatment device to an underground formation.

2. The method of claim 1 wherein the high pour point well treatment chemical comprises at least one of the following selected from: emulsifiers, corrosion inhibitors, scale inhibitors, non-emulsifiers, wetting agents, sludge preventives, retarders, suspension agents, anti-swelling agents, or stimulation additives.

3. The method of claim 1 further comprising:
providing a second precipitated amorphous silica matrix;
mixing a second well treatment chemical with the precipitated amorphous silica to form a second solid treatment device; and
providing the second solid treatment device with the first solid treatment device to the underground formation;
wherein the high pour point well treatment chemical and the second well treatment chemical do not interact when contained in the first solid treatment device and second solid treatment device.

4. The method of claim 3 wherein the high pour point well treatment chemical and second well treatment chemical are reactive with one another.

5. The method of claim 1 further comprising coating the first solid treatment device.

6. The method of claim 5 wherein the coating is polyvinylidene chloride.

7. The method of claim 5 wherein the coating is an acrylic resin.

8. The method of claim 1 wherein the surface area of the precipitated amorphous silica matrix is in excess of 80 square meters per gram.

9. The method of claim 2 wherein the high pour point well treatment chemical is an acid and the second well treatment chemical is a base.

10. The method of claim 1 wherein the first solid treatment device is a dimpled spheroid.

11. A method for delivering a chemical agent in a solid form, the method comprising:
heating the chemical agent to reduce its pour point;
mixing the chemical agent with an amorphous precipitated silica carrier to form a solid composite; and
depositing the solid composite into the wellbore;
wherein the liquid chemical agent is released from the solid composite in a metered manner in the wellbore.

12. The method of claim 11 wherein the chemical agent comprises at least one of the following selected from: scale inhibitors, corrosion inhibitors, paraffin products, H₂S scavengers, or foamers.

13. The method of claim 11 further comprising:
providing a second solid composite formed of an amorphous precipitated silica carrier and a second liquid chemical agent; and
depositing the second solid composite into the wellbore.

14. The method of claim 13 wherein the first liquid chemical agent is an acid and the second liquid chemical agent is a base.

15. The method of claim 13 wherein one of the solid composite and the second solid composite is coated with a degradable coating.

16. The method of claim 11 further comprising coating the solid composite with acrylic resin.

17. The method of claim 11 wherein the surface area of the amorphous precipitated silica is in excess of 80 square meters per gram.

18. The method of claim 11 wherein the melting point of the chemical agent exceeds the highest temperature of the wellbore.

19. The method of claim 11 further comprising mixing the solid composite with a guar powder.
